(19) United States
(12) Patent Application Publication
(10) Pub. No.: US 2009/0296270 A1
(43) Pub. Date: Dec. 3, 2009

(54) THERMAL FLYHEIGHT CONTROL HEATER PRECONDITIONING

(76) Inventors: Zhen JIN, Fremont, CA (US); Albert Wallash, Morgan Hill, CA (US); Hong Zhu, Katy, TX (US)

Correspondence Address: HITACHI C/O WAGNER BLECHER LLP, 123 WESTRIDGE DRIVE, WATSONVILLE, CA, 95076, US

(21) Appl. No.: 12/127,319

(22) Filed: May 27, 2008

(51) Int. Cl. G11B 33/14

(52) U.S. Cl. 360/97.02

(57) ABSTRACT

Systems and methods for magnetic head preconditioning using a thermal flyheight control heater are discussed. The method of manufacturing the magnetic head comprises measuring a bit error performance of the magnetic head, heating the magnetic head with the thermal flyheight control heater, measuring another bit error rate performance, and determining a performance increase based on comparing the bit error rate performances. The heating of the magnetic head is performed while the magnetic head is unloaded from a disk. An element within the magnetic head is deformed plastically.

### TECHNICAL FIELD

Embodiments of the present technology relate generally to the field of hard disk drives.

### BACKGROUND

During magnetic head fabrication, etching and lapping procedures are used to recess and erode materials to obtain desired parameters. Etching and lapping processes are controlled, but unfortunately not exact. A potential difficulty in controlling etching and lapping processes is that different materials have different erosion rates. Different erosion rates may cause varying pole-tip erosions which may lead to non-optimized bit error rate performance.

### SUMMARY

Systems and methods for magnetic head preconditioning using a thermal flyheight control heater are discussed herein. The method of manufacturing the magnetic head comprises measuring a bit error performance of the magnetic head, heating the magnetic head with the thermal flyheight control heater, measuring another bit error rate performance, and determining a performance increase based on comparing the bit error rate performances. The heating of the magnetic head is performed while the magnetic head is unloaded from a disk. An element within the magnetic head is deformed plastically.

### BRIEF DESCRIPTION OF THE DRAWINGS

The accompanying drawings, which are incorporated in and form a part of this specification, illustrate embodiments of the presented technology and, together with the description, serve to explain the principles of the presented technology:

FIG. 1 illustrates a magnetic head prior to etching and lapping, in accordance with an embodiment of the present technology.

FIG. 2 illustrates a magnetic head after etching and lapping and prior to preconditioning, in accordance with an embodiment of the present technology.

FIG. 3 illustrates a magnetic head after preconditioning, in accordance with an embodiment of the present technology.

FIG. 4 is a graph illustrating bathtub curves for bit error rate as a function of an offset, in accordance with an embodiment of the present technology.

FIG. 5 is a graph illustrating bit error rates as a function of thermal flyheight control heater preconditioning power, in accordance with an embodiment of the present technology.

FIG. 6 is a flow diagram of an example method of manufacturing a magnetic head, in accordance with an embodiment of the present technology.

The drawings referred to in this description should not be understood as being drawn to scale unless specifically noted.

### DESCRIPTION OF EMBODIMENTS

Reference will now be made in detail to the alternative embodiments of the present technology. While numerous specific embodiments of the present technology will be described in conjunction with the alternative embodiments, it will be understood that they are not intended to limit the present technology to these embodiments. On the contrary, these described embodiments of the present technology are intended to cover alternatives, modifications and equivalents, which may be included within the spirit and scope of the embodiments as defined by the appended claims.

Furthermore, in the following description of embodiments, numerous specific details are set forth in order to provide a thorough understanding of the present technology. However, it will be recognized by one of ordinary skill in the art that embodiments may be practiced without these specific details. In other instances, well known methods, procedures, components, and circuits have not been described in detail as not to obscure unnecessarily aspects of embodiments of the present technology.

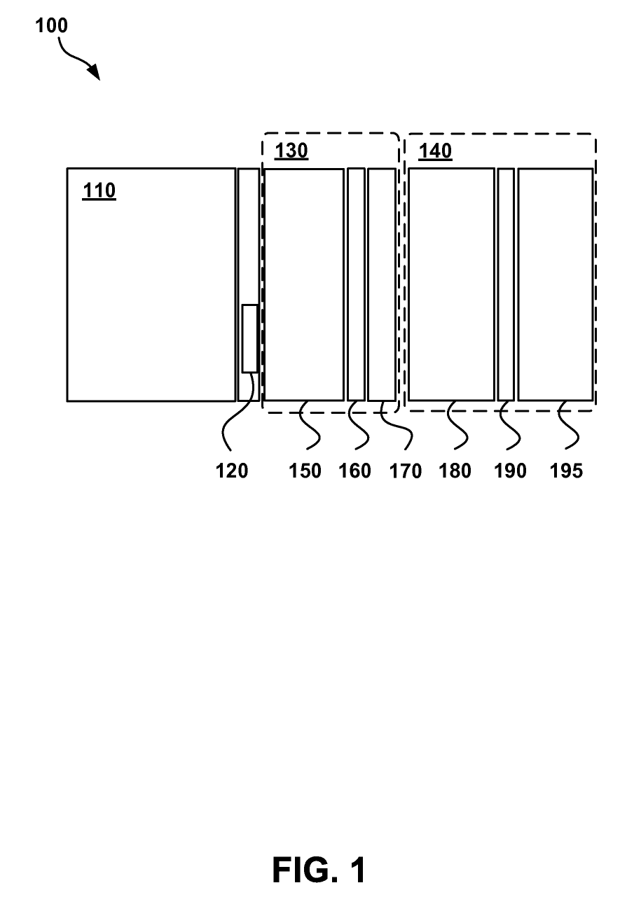

FIG. 1 illustrates a magnetic head 100 prior to etching and lapping, in accordance with an embodiment of the present technology. The magnetic head 100, fabricated by layering, comprises a substrate 110, a thermal flyheight control heater 120, a read element 130, and a write element 140. The read element 130 comprises a shield 150, a reader 160, and a shield 170. The write element 140 comprises a bottom pole 180, a writer 190, and a top pole 195. The thermal flyheight control heater 120 may be in various locations within the magnetic head, such as between the reader 160 and the writer 190 or on the other side of the writer 190. In various embodiments, the shield 170 and the bottom pole 180 have an insulation layer (not depicted) between them. In various embodiments, the magnetic head 100 may comprise only one of the read element 130 or the write element 140. In various embodiments, the write element 140 may be between the substrate 110 and the read element 130.

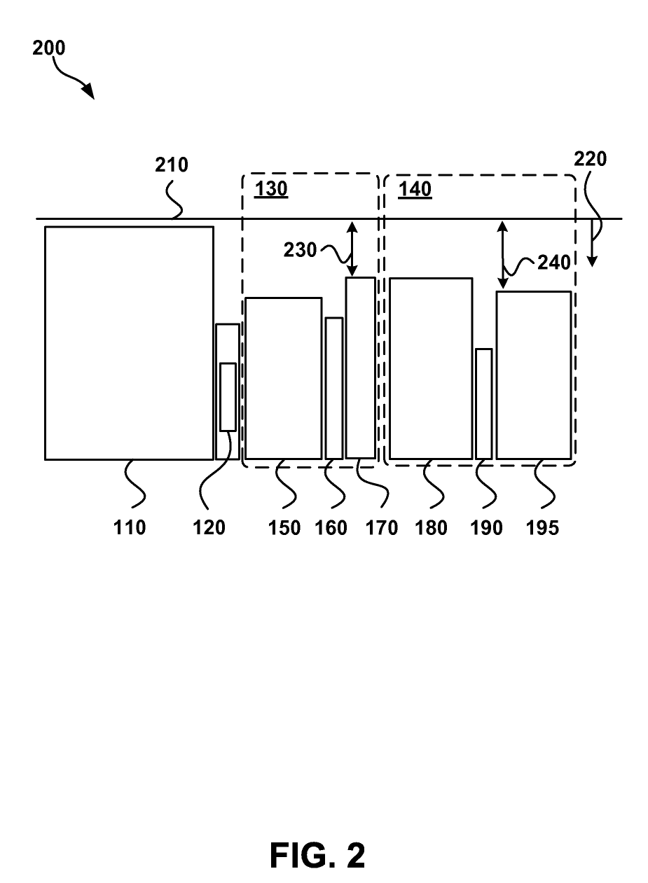

FIG. 2 illustrates a magnetic head 200 after etching and lapping and prior to preconditioning, in accordance with an embodiment of the present technology. During fabrication, a profile of a magnetic head changes as layers are recessed. The magnetic head 200 illustrates erosion and/or recession, a fabrication effect of etching and lapping, of the magnetic head 100, as indicated by an arrow 220 from a disk surface 210. The arrow 220 indicates a direction of the erosion and recession during fabrication. The amount of lapping and etching may induce more erosion and/or recession for less tolerant materials. For example, the top pole 195 may experience more erosion and/or recession than the shield 170, as indicated a gap 240 being greater than a gap 230.

Rates of erosion and/or recession vary depending on etching and lapping parameters, such as duration and intensity, materials of the layers, thicknesses of the layers, proximity of layers to less tolerant layers, proximity to the substrate 110, and the like. The proximity of layers to less tolerant layers may erode less as the more tolerant materials provide a shield to prevent some erosion and/or recession of the less tolerant materials. The farther the distance is from the substrate 110, the more the layer is influenced by lapping/etching. For example, the writer 190 may experience more erosion and/or recession than the reader 160 due to the writer 190 being farther from the substrate 110. Metal and alumina layers may be recessed by a couple of nanometers, depending on the different material removal rates.

During operation, the thermal flyheight control heater 120 may be used to control a distance between the magnetic head 200 and the disk surface 210 while the magnetic head 200 is loaded onto the disk. As a current is applied to the thermal flyheight control heater 120, the heater 120 heats the magnetic head 200 and thermally expands the read element 130 and/or the write element 140. The expansion closes a gap or gaps between the disk surface 210 and the read element 130 and/or the write element 140. Typically, by thermal flyheight control heater design, the expansion is elastic as the disk rotating at high velocities acts as a heat sink. During standby, the magnetic head 200 is unloaded from the disk and an aperture (not depicted) attached to the magnetic head 200 rests on a ramp (not depicted). During standby, the magnetic head 200 may be parked for protection.

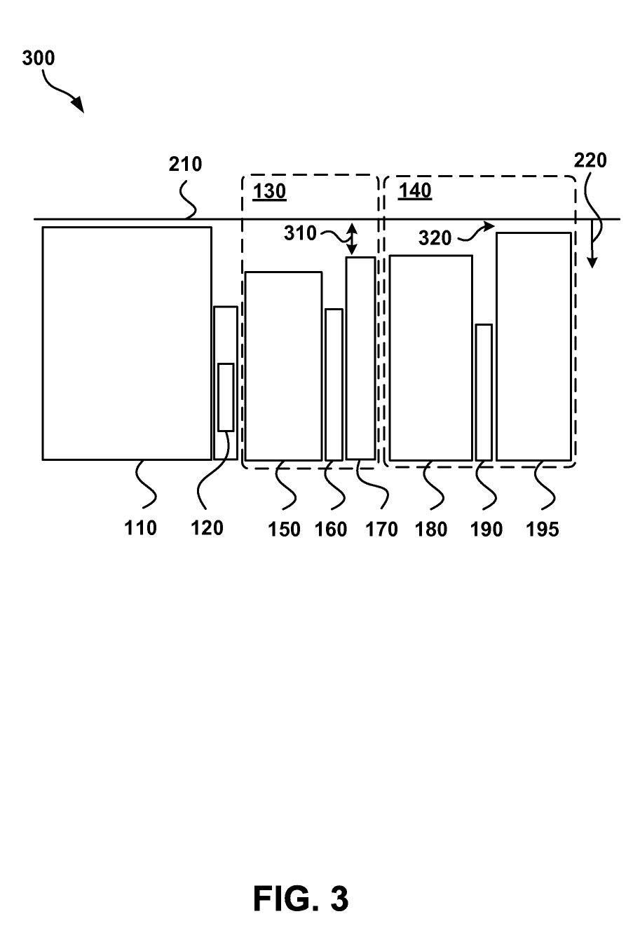

FIG. 3 illustrates a magnetic head 300 after preconditioning, in accordance with an embodiment of the present technology. The magnetic head 300 illustrates effects of preconditioning the magnetic head 200. During preconditioning, the thermal flyheight control heater 120 heats the magnetic head and plastically deforms the read element 130 and/or the write element 140. The plastic deformation may reduce gaps between the disk surface 210 and the read element 130 and/or the write element 140. For example, a gap 310 is smaller than the gap 230 and a gap 320 is smaller than the gap 240. The reduced gap may permit the read element 130 and/or the write element 140 to be closer to the disk surface 210 during operation as the substrate 110 is less of an obstacle. For example, prior to preconditioning a gap, such as the gap 230, may be two nanometers, while after preconditioning the gap, such as the gap 320 may be 0.2 nanometers. The narrower gap between an element and a disk surface results in a lower bit error rate. The reduced gap may also allow for lower power consumption by the thermal flyheight control heater 120 for the same operating performance and/or greater performance. In some embodiments, the reduced gap may allow the magnetic head 300 to operate with little to no power consumption by the thermal flyheight control heater 120. In various embodiments, the read element 130 and/or the write element may plastically deform up to twelve nanometers.

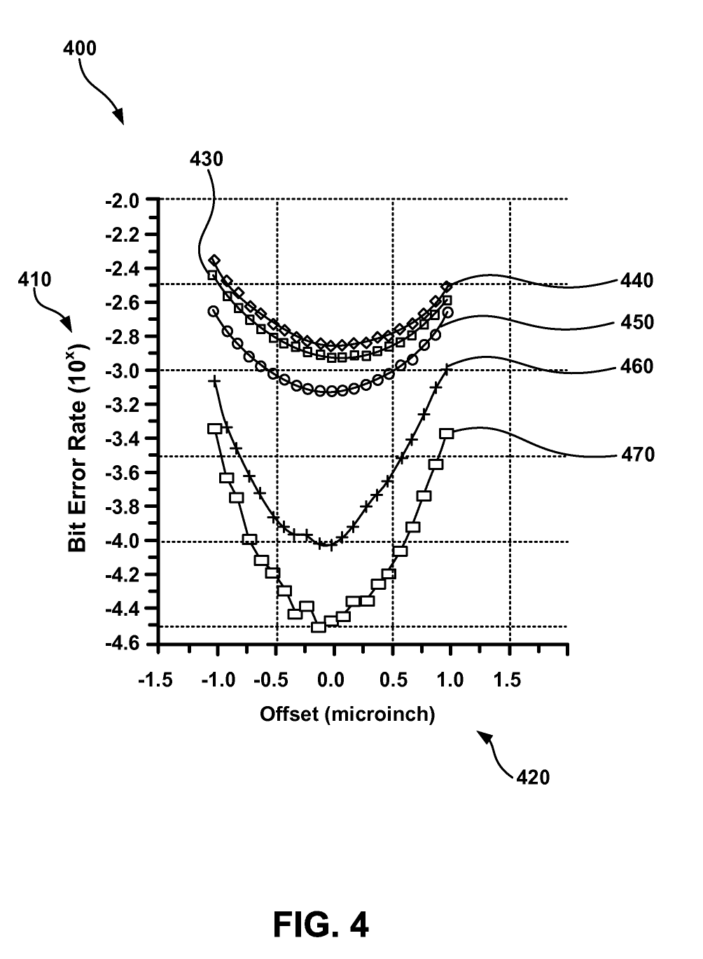

FIG. 4 is a graph 400 illustrating bathtub curves for a bit error rate as a function of an offset, in accordance with an embodiment of the present technology. The graph 400 comprises curves 430, 440, 450, 460 and 470. A vertical axis 410 is a bit error rate and has a logarithmic scale. For example, “−3” represents one error in a thousand and “−4” represents one error in ten thousand. A horizontal axis 420 is an offset. The offset is measured from a center of a track on a disk and measured in micro-inches. The curve 430 represents data taken from a magnetic head with no preconditioning. The curve 440 represents data taken from a magnetic head with preconditioning with a thermal flyheight control heater power at 60 milliwatts. The curve 450 represents preconditioning at 80 milliwatts. The curve 460 represents preconditioning at 100 milliwatts. The curve 470 represents multiple preconditionings at 100 milliwatts. As illustrated, bit error rates do not improve within the range of 0 to 60 milliwatts. At approximately 80 milliwatts, the bit error rate performance improves a little as shown with the curve 450. The bit error rate performance improves by more than a factor of ten at 100 milliwatts compared with no preconditioning, as illustrated by comparing the curve 430 and the curve 460.

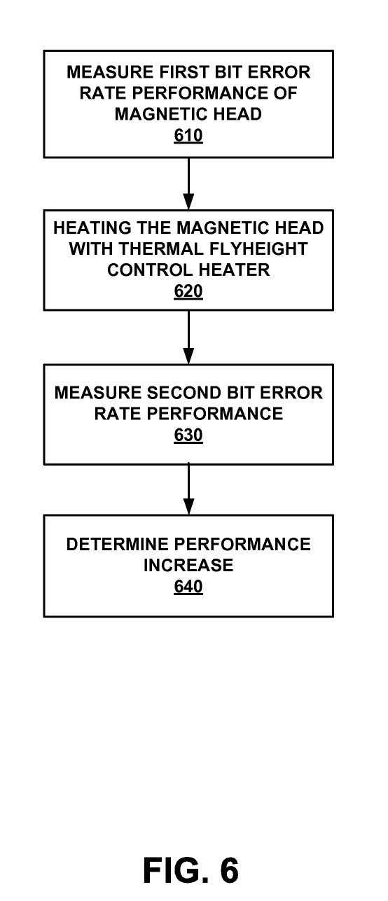

The curve 470 shows data for a magnetic head that has been preconditioned multiple times which further improved bit error rate performance. Multiple preconditioning may be controlled by measuring an initial bit error rate, measuring a bit error rate after each preconditioning, and determining a performance increase based on the measurements. Multiple preconditioning is discussed further with regards to FIG. 6 and herein.

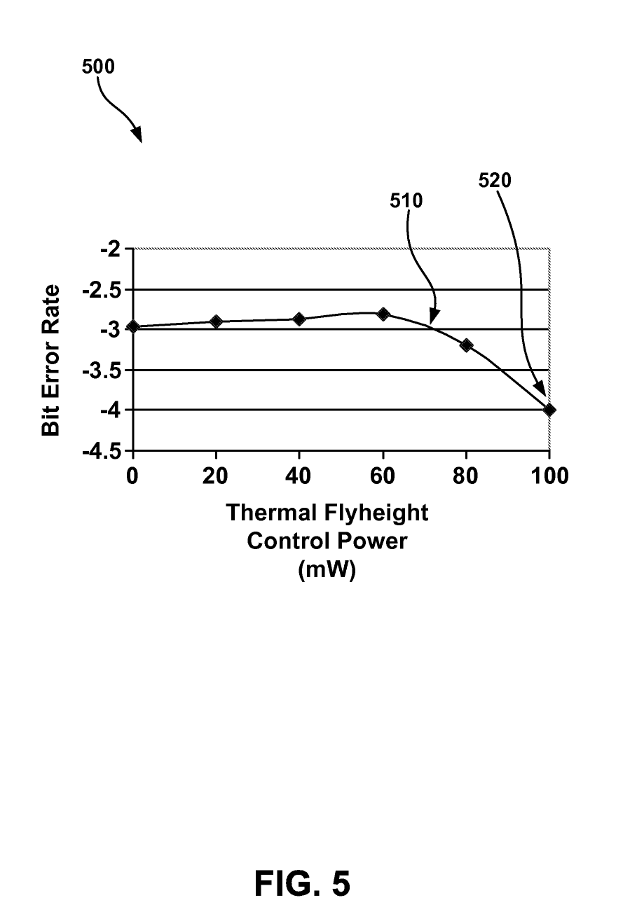

FIG. 5 is a graph 500 illustrating bit error rates as a function of thermal flyheight control heater preconditioning power, in accordance with an embodiment of the present technology. The graph 500 shows bit error rates for the preconditioning powers of graph 400 taken at a zero offset. Also shown are bit error rates at powers of 20 milliwatts and 40 milliwatts. As shown with arrow 510, using interpolation, the bit error rate performance increases using preconditioning powers above 70 milliwatts. Arrow 520 shows that the bit error rate performance may be increased ten fold using powers at 100 milliwatts. Further tests (not shown) show that preconditioning above 120 milliwatts has detrimental effects, such as a read element and/or a write element plastically deforming beyond a safe zone, crashing into a disk surface, and/or malfunctioning.

FIG. 6 is a flow diagram of an example method of manufacturing a magnetic head, in accordance with an embodiment of the present technology. Bit error rate performances for magnetic heads may be improved using preconditioning. In some embodiments, several precondition steps may be used as to optimize performance without undue risk of over plastically deforming elements within the magnetic head. In step 610, a first bit error rate performance is measured. The bit error rate performance may be measured under testing conditions at a test stand, after the magnetic head is installed in a disk drive, or during any other conditions where the bit error rate may be measured.

In step 620, the magnetic head is heated using a thermal flyheight control heater, such as heater 120, while the magnetic head is unloaded from the disk. In various embodiments, the preconditioning may comprise one heating or several heatings. If several heatings are used, the heatings will typically start at lower power levels, such as 60 milliwatts and gradually increase after an improvement is measured.

In step 630, a second bit error rate performance is measured and, in step 640, an increased performance is determined. In various embodiments, reheating the magnetic head continues until the increased performance reaches a target level, such as an improvement factor of ten. In other embodiments, the reheating continues until an upper power limit is reached, such as 120 milliwatts. In this way, each magnetic head may be optimized individually. Actual upper power limits may be dependent on magnetic head configuration, such as the location of heaters, heat sinks, and material properties within the magnetic head.

In various embodiments, power level and duration conditions may be determined for a batch of similar magnetic heads, and used to precondition the heads in a similar fashion. For example, for a batch of 1000 magnetic heads, it is determined that applying 100 milliwatts for five seconds produces a desired result. So, instead of optimizing each magnetic head individually, the entire batch may be preconditioned similarly, that is, at 100 milliwatts for five seconds.

The foregoing descriptions of example embodiments have been presented for purposes of illustration and description. They are not intended to be exhaustive or to limit the teaching to the precise forms disclosed. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of manufacturing a magnetic head comprising:
measuring a first bit error rate performance of the magnetic head;
heating the magnetic head with a thermal flyheight control heater while the magnetic head is unloaded from a disk, wherein an element within the magnetic head deforms plastically;
measuring a second bit error rate performance; and
determining a performance increase based on comparing the first bit error rate performance and second bit error rate performance.

2. The method of claim 1, further comprising repeating the heating and determining the performance increase until a desired increase in performance is obtained.

3. The method of claim 2, wherein the repeating continues until a power of the thermal flyheight control heater reaches a specified limit.

4. The method of claim 3, wherein the specified limit is approximately 120 milliwatts.

5. The method of claim 1, wherein a power of the thermal flyheight control heater is approximately within a range of 70 to 120 milliwatts.

6. The method of claim 1, wherein the heating is for a duration of between three to ten seconds.

7. The method of claim 1, wherein the measuring of the first bit error rate and the measuring of the second bit error rate occur while the magnetic head is loaded onto the disk.

8. The method of claim 1, wherein the element is plastically deformed approximately within a range of two nanometers and six nanometers.

9. The method of claim 1, wherein the element comprises a read element, further comprising a write element, wherein the heating deforms plastically the read element and the write element.

10. A method comprising:
measuring a first bit error rate performance of a magnetic head;
heating the magnetic head with a thermal flyheight control heater while the magnetic head is unloaded from a disk, wherein a read element or a write element within the magnetic head deforms plastically;
measuring a second bit error rate performance;
determining a performance increase based on comparing the first bit error rate performance and second bit error rate performance; and
repeating the application of heating and determining the performance increase until a desired increase in performance is obtained or a power of the thermal flyheight control heater reaches a specified limit.

11. The method of claim 10, wherein the specified limit is approximately 120 milliwatts.

12. The method of claim 10, wherein the power is approximately within a range of 70 to 120 milliwatts.

13. The method of claim 10, wherein the heating is for a duration of between three to ten seconds.

14. The method of claim 10, wherein the measuring of the first bit error rate and the measuring of the second bit error rate occurs while the magnetic head is loaded onto the disk.

15. The method of claim 10, wherein the read element or the write element is plastically deformed approximately within a range of two nanometers and six nanometers.

16. The method of claim 10, wherein the heating plastically deforms the read element and the write element.

17. A method of preconditioning a magnetic head comprising:
unloading a magnetic head; and
heating the magnetic head with a thermal flyheight control heater while the magnetic head is unloaded from a disk, wherein a read element or a write element within the magnetic head deforms plastically, wherein the heating is controlled for a specified power and a specified duration.

18. The method of claim 17, wherein the specified power is approximately within a range of 70 to 110 milliwatts.

19. The method of claim 17, wherein the specified power is approximately 100 milliwatts.

20. The method of claim 17, wherein the specified duration is between three to ten seconds.
